(19) United States
(12) Patent Application Publication
(10) Pub. No.: US 2014/0289606 A1
(43) Pub. Date: Sep. 25, 2014

(54) Systems and Methods For Attribute Indication and Accessibility in Electronics Documents

(71) Applicant: Arun Koormamtharayil, Calicut, IN (US)

(72) Inventor: Arun Koormamtharayil, Calicut, IN (US)

(73) Assignee: Adobe Systems Incorporated, San Jose, CA (US)

(21) Appl. No.: 12/142,543

(22) Filed: Jun. 19, 2008

(51) Int. Cl. G06F 17/00

(52) U.S. Cl. 715/234

(57) ABSTRACT

Systems and methods for attribute indication and accessibility in electronic documents are disclosed. For example, one disclosed method includes the steps of identifying a first characteristic associated with a first scene and a second scene in a script, the script comprising a plurality of scenes; associating a first indicator with the first scene and the second scene, the first indicator indicating the presence of the first characteristic; receiving a selection of the first indicator; and outputting the first scene and the second scene based at least in part on the selection.

### FIELD

The present invention generally relates to electronic documents and more specifically relates to attribute indication and accessibility in electronic documents.

### BACKGROUND

Electronic documents have become a ubiquitous medium for communicating information, and they may be created and edited by a wide variety of applications. For example, word processing software allows a user to draft electronic documents, such as research papers, articles, books, and scripts. These applications may also include the ability to add comments to an electronic document, or other features to indicate important or noteworthy content, such as highlighting. For example, some word processing programs allow a user to create a table of contents at the beginning of a document that can be used to navigate the document electronically. The word processing program may allow a user to click on a table of contents entry, which will cause the program to display the selected page or portion of the electronic document corresponding to the selected table of contents entry. Other programs may allow a user to provide visual cues to indicate that a part of a document is related to another part of the document. For example, a program may allow a user to view multiple pages of an electronic document simultaneously. A common visual cue present on multiple pages may indicate to a user that the different pages may have common content.

### SUMMARY

Embodiments disclosed provide systems and methods for attribute indication and accessibility in electronic documents. For example, one embodiment comprises a computer-implemented method having the steps of identifying a first characteristic associated with a first scene and a second scene in a script, the script comprising a plurality of scenes; associating a first indicator with the first scene and the second scene, the first indicator indicating the first characteristic; receiving a selection of the first indicator; and outputting the first scene and the second scene based at least upon the selection. In another embodiment, a computer-readable media comprises code for carrying out such a method.

These illustrative embodiments are mentioned not to limit the disclosure, but to provide examples to aid understanding thereof. Illustrative embodiments are discussed in the Detailed Description, and further description is provided there. Advantages offered by various embodiments may be further understood by examining this specification.

### BRIEF DESCRIPTION OF THE DRAWINGS

These and other features, aspects, and advantages of the present disclosure are better understood when the following Detailed Description is read with reference to the accompanying drawings, wherein:

FIG. 1 shows a software application for attribute indication and accessibility in electronic documents according to one illustrative embodiment;

FIG. 2 shows a system for attribute indication and accessibility in electronic documents according to one disclosed embodiment;

FIG. 3 shows a flowchart of a method for attribute indication and accessibility in electronic documents according to one disclosed embodiment;

FIG. 4 shows a software application for attribute indication and accessibility in electronic documents according to one illustrative embodiment;

FIG. 5 shows a software application for attribute indication and accessibility in electronic documents according to one embodiment;

FIG. 6 shows a software application for attribute indication and accessibility in electronic documents according to one embodiment;

FIG. 7 shows a software application for attribute indication and accessibility in electronic documents according to one embodiment; and

FIG. 8 shows a software application for attribute indication and accessibility in electronic documents according to one embodiment.

### DETAILED DESCRIPTION

This disclosure describes embodiments of systems and methods for attribute indication and accessibility in electronic documents. Embodiments disclosed allow a user to identify characteristics present in a document and to use those indicators associated with those identified characteristics to quickly access parts of the document that are associated with the characteristic. For example, using one embodiment, a screenwriter can assign an indicator to several scenes in a screenplay that make up a subplot of the movie. Then, when the screenwriter is revising the script, she can select the indicator associated with the subplot to quickly access only those scenes that are relevant to the subplot. This may allow the screenwriter to more easily develop the subplot, or to eliminate unnecessary scenes from the movie script. Additionally, the indicator may also be associated with additional information associated with the work, such as a biography or character background information, location information, or other information within the work that provides additional information about characteristics within the work. By allowing a user to quickly access the desired parts of an electronic document, the user may be able to more quickly and efficiently work with their electronic documents.

In addition to the possible advantages discussed above, users besides the screenwriter may be able to take advantage of improvements in efficiency provided by embodiments disclosed herein. For example, a location specialist, who works as part of the movie production, may be able to select one or more indicators associated with scene locations in the screenplay. This may allow the location specialist to efficiently plan the filming of the movie based on which scenes require travel to different locations. Further, other types of works may be advantageously created and edited with embodiments, such as TV show scripts, film scripts, corporate video presentation scripts, commercial scripts, animation scripts or story boards, multimedia presentation scripts or storyboards, a presentation script, a book (such as a short story, novel, biography, etc.). Thus, embodiments may allow an author of an electronic document to work more efficiently when writing the document, but also may allow other users of the document to access the information needed for their role, such as in a theatrical or dramatic production. These and other advantages and benefits may be found by examining the following description.

### Illustrative Attribute Indication and Accessibility

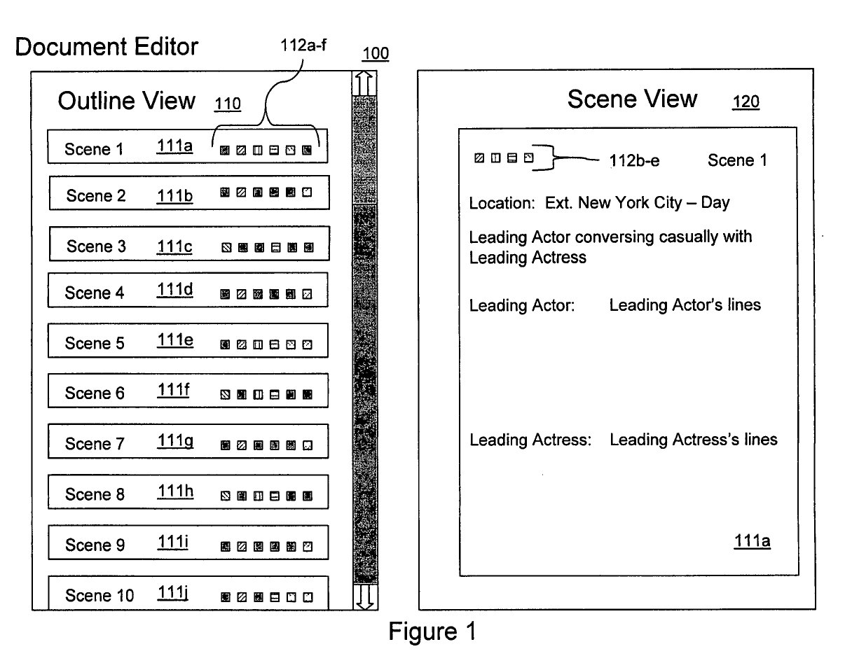

Referring now to FIG. 1, FIG. 1 shows a software application for attribute indication and accessibility according to one illustrative embodiment. The embodiment shown in FIG. 1 includes a software application for editing and working with a script, such as for a movie, play, musical, documentary, or television show. The software application includes a main screen 100 that is displayed to a user. The main screen 100 includes two windows 110, 120 for displaying information to the user. The outline window 110 includes a listing of the scenes in the movie script, while the scene window 120 displays one or more selected scenes.

In the embodiment shown in FIG. 1, scene 1 is displayed in the scene window 120. Scene 1 includes two actors, the lines the actors will deliver in the scene, information about the location and time of day, as well as the action taking place in the scene. In the outline window 110, a list of scenes 111a-j is shown to the user. A user may select a scene to view by moving a cursor onto the desired scene and clicking the scene.

In addition to the simple listing of the scenes, the outline window 110 also includes several boxes 112a-f associated with each of the scenes 111a-j. In the embodiment shown in FIG. 1, each of the boxes 112a-f is associated with an attribute of the movie script. For example, box 112a corresponds to special effects, while box 112b corresponds to time of day. The other boxes 112c-f correspond to the leading actor and leading actress, and two different locations that are used frequently within the movie script. When a box 112a-f has been filled in or colored, it indicates that an attribute is present in the scene. For example, scene 111a includes four boxes that are filled in: the second box 112b that has been filled in indicates that the scene occurs during the day, the next box 112c indicates that the leading actor is in the scene, the fourth box 112d indicates that the leading actress is in the scene, and the fifth box 112e indicates that the scene occurs in New York City. In addition to the display in the outline view 110, the scene view 120 also includes the indicators 112b-e associated with the scene 111a being viewed.

A user of the embodiment shown in FIG. 1 may be able to group scenes according to which actors appear in the scene, which scenes occur in particular locations, and which scenes require special effects. For example, a location specialist may select the box 112e that corresponds to scenes that occur in New York City in order to group the filming of those scenes together to cut down on production costs. The software application, upon receiving the selection of the box 112e will search each of the scenes and determine which scenes occur in New York City, and display them to the user. For example, the software application may change the appearance of the outline window 110 to only include the scenes that occur in New York City.

Alternatively, a screen writer may use the software application differently than another user. For example, a screen writer may create a new box to correspond to a different attribute. For example, the screenwriter may want to view all scenes associated with a sub-plot. The screenwriter may create an indicator for the sub-plot and assign a box to the indicator. The screenwriter may then associate the indicator with each of the scenes that make up the subplot. Once all of the indicators have been assigned, the screenwriter can, at a later time, review the scenes in the sub-plot and edit the script, such as by adding additional scenes to expand on the story, or by deleting scenes that are unnecessary to the development of the sub-plot. The software application may thus aid the screenwriter in developing and revising the movie script.

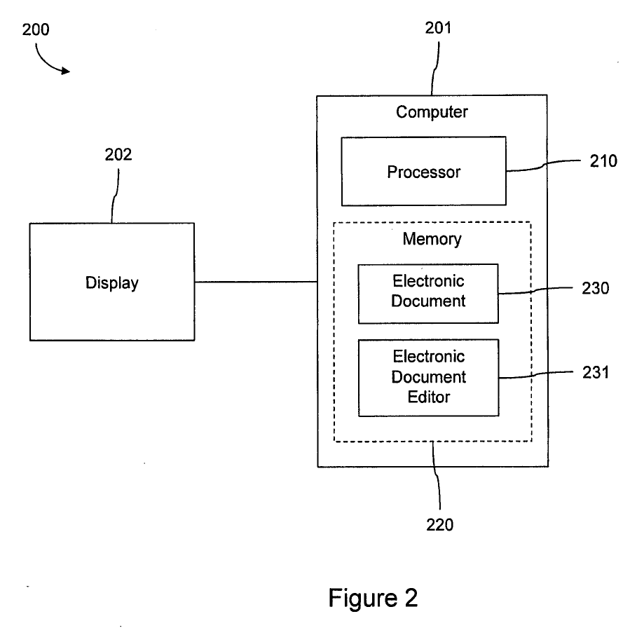

Referring now to FIG. 2, FIG. 2 shows a system for attribute indication and accessibility according to one disclosed embodiment. In the embodiment shown, the system 200 comprises a computer 201 in communication with a display 202. The computer 201 comprises a processor 210 and a memory 220. Within the memory 220, the computer has an electronic document 230 and an electronic document editor 231.

In one embodiment, the electronic document editor 231 is configured to allow a user to identify a characteristic associated with a first scene and a second scene in a script, the script comprising a plurality of scenes. A script is simply an electronic document, or multiple electronic documents that are associated with each other in a coherent manner, that serves as the script for a theatrical or dramatic work, such as a play, musical, movie, television show, or documentary. In some embodiments, a script may comprise a plurality of electronic documents. For example, each scene in a script may be stored in a separate electronic document.

As used herein, a characteristic corresponds to a property within a scene or script. For example, in one embodiment, a script comprises a movie script, and a scene comprises a character and a subplot. In such an embodiment, a characteristic may comprise the character or the subplot. In another embodiment, a script comprises a musical, and a characteristic of a scene or act may comprise a song or melody.

The electronic document editor 231 is also configured to associate a first indicator with the first scene and the second scene, the first indicator indicating the presence of the first characteristic. An indicator is data that can be used to identify the presence of a characteristic. For example, an indicator may be data that is inserted into an electronic document, such as a comment or annotation. In one embodiment, the electronic document editor 231 generates metadata that is inserted into an electronic document. In another embodiment, a script may comprise a screenplay having a plurality of scenes. In such an embodiment, the screenplay may be stored in one or more documents having a file format that supports data describing characteristics. For example, the file format may support extensible markup language (XML) tags to identify the presence of a characteristic. In such an embodiment, the XML tags may also identify the location of the characteristic. In still a further embodiment, the electronic document editor 231 may not modify the electronic documents, but may instead generate a new document to store one or more indicators, as well as the association of the indicators with scenes within the work.

The electronic document editor 231 is further configured to receive a selection of the indicator. For example, in the embodiment shown in FIG. 1, a user may move a cursor over one of the colored boxes 112a-f and click a mouse button to select the desired colored box. In such an embodiment, the electronic document editor 231 receives the selection of the indicator—the selected colored box. In another embodiment, the system 200 may include a touch-sensitive display, and a user may touch the screen at a location corresponding to an indicator, causing the system 200 to receive a selection of the indicator. In still a further embodiment, a user may select a desired indicator from a drop-down menu or the user may type in a description of the indicator, such as a character's name.

The electronic document editor 231 is further configured to output the first scene and the second scene based at least in part on the selection. For example, the electronic document editor 231 may display the first and second scenes. In such an embodiment, the electronic document editor may display two scenes of a script that comprise the selected character. In another embodiment, the electronic document editor 231 may display representations of the first and second scenes. In such an embodiment, the electronic document editor 231 may display stylized pieces of paper with a page number to indicate the pages in the script on which the selected character can be found.

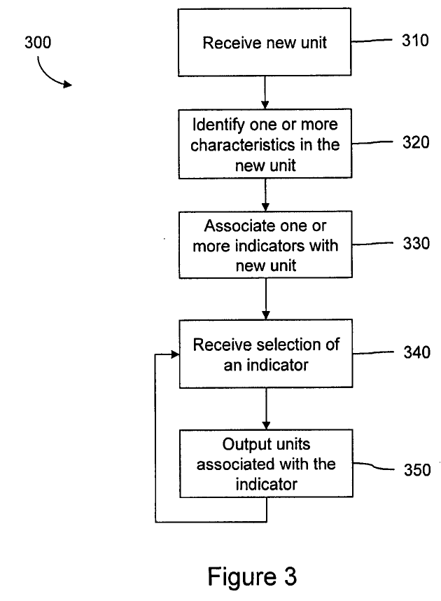

Referring now to FIG. 3, FIG. 3 shows a flowchart of a method 300 for attribute indication and accessibility in electronic documents according to one disclosed embodiment. The embodiment shown in FIG. 3 will be discussed in terms of the system 200 shown in FIG. 2.

In the embodiment shown, the method 300 begins with step 310 when the processor 210 receives a new scene to be included in a script. For example, in one embodiment, a screenwriter may be drafting a movie script and want to add a new scene to the script. The screenwriter may select a menu option to add a new scene to the script from a user interface displayed on display 202. The user may be presented with a blank electronic page on which he may write the scene, such as by typing in dialogue, information about lighting and location, and so forth. Or the user may begin a new movie script from scratch, and write a plurality new scenes for the script in the electronic document editor 231. In another embodiment, a user may create a new, blank script using the electronic document editor 231 and import pre-existing content into the script. For example, a user may have drafted a screenplay using a conventional word processing program. The user may select an ‘Import’ option from a menu in a user interface displayed on display 202. The electronic document editor may then import the screenplay. In a further embodiment, a user may import an existing scene into a script already within the electronic document editor 231.

The method 300 continues in block 320 where one or more characteristics in the new scene are identified. For example, a user drafting a movie script using the electronic document editor 231 may draft a new scene for the movie script. After the user has created the draft of the scene, the user may examine the indicators that have already been associated with the movie script and identify characteristics that correspond with one or more of the indicators. For example, the script may comprise an indicator for the leading actor in the movie, and the user may identify the fact that the leading actor appears in the new scene. Alternatively, the user may have created the new scene to correspond to a new subplot within the movie. The user may then identify the new subplot as a characteristic. In a further embodiment, the user may cause the electronic document editor to automatically identify one or more characteristics within the new scene. For example, the user may select an option from a menu to cause the electronic document editor to scan the scene for characteristics that are associated with one or more indicators associated with the work. For example, a work may have an indicator associated with an actor's name. The electronic document editor 231 may be configured to automatically scan each scene in the work for the actor's name associated with the indicator. In another embodiment, the electronic document editor 231 may automatically identify one or more characteristics associated with the work and may automatically associate one or more indicators with a scene based at least in part on the one or more characteristics. For example, the electronic document editor may identify an actor's name and identify each scene in which the actor's character appears.

In step 330, one or more indicators are associated with the new scene based at least in part on the characteristics within the new scene. For example, in an embodiment in which a user has created a new scene for a movie script and identified that the leading actor appears in the new scene, the indicator corresponding to the leading actor may be associated with the new scene. For example, the user may select an indicator from a drop-down menu to associate the appropriate indicator with the scene. In another embodiment, the user may drag an indicator from a menu or a pool of available indicators onto a representation of the scene to associate the characteristic with the scene.

In one embodiment, to associate an indicator with a characteristic of a scene, a new indicator may be created. For example, a new scene may be added to a script, where the new scene is associated with a new character in a play. The author may decide that the new character will play a prominent role in the play, and thus identify the character as a characteristic of the scene in the play in which the character first appears. The author may also desire to add an indicator to correspond to the character. The author may select an option available in the electronic document editor 231 to add a new indicator. The author may then select a color or a shape for the indicator, and enter information about the characteristic to be associated with the indicator. For example, the author may create an indicator having the shape of an outline of person. This may indicate, upon a quick glance, that the indicator is an indicator for a character in the play. The user may then select the color green to correspond to the new character in the play. In another embodiment, an indicator may comprise an icon corresponding to a time of day. For example, an indicator may comprise a sun-shaped icon to indicate a daytime scene or a crescent-shaped icon to indicate a night-time scene. In other embodiments, a user may select different shapes or colors for indicators to provide useful information to someone viewing the work in the electronic document editor 231.

Additionally, other users of the document may identify a characteristic of a scene and associate an indicator with the scene based at least in part on the characteristic. For example, a special effects specialist may identify characteristics of scenes related to special effects, and may assign one or more indicators based at least in part on the one or more characteristics. Similarly, an actor may identify one or more characteristics of a scene of interest to the actor, such as emotions, scenes with singing, or other activities to aid the actor or another person in preparing for the scenes. In one embodiment of the present invention, a system 200 for attribute indication and accessibility in electronic documents may be configured to identify a plurality of characteristics of a plurality of scenes in a work, and to associate indicators with each of the plurality of scenes. The system 200 may further be configured to group indicators based at least in part on a user who identified the characteristic or a group associated with the work. For example, a plurality of users of a system 200 may each identify characteristics and associate attributes with the characteristics. The system may allow each of the users to display only indicators added by the user, or to display indicators added by any member of the special effects group working with the electronic document. Such an embodiment may be advantageous because it may only display indicators relevant to an individual user.

Further, the steps of identifying the characteristic 320 in the new scene and associating one or more indicators 330 with the new scene may happen in rapid succession, or even substantially simultaneously. For example, in the embodiment shown in FIG. 1, a user may move a cursor over the outline view 110 in the electronic document editor 231, and right-click a mouse button while the cursor is over one of the listed scenes. This may cause a context-sensitive menu to be displayed with a listing of the available indicators. The user scans the list of indicators and identifies a characteristic by noticing that one of the indicators corresponds to a characteristic within the new scene. The user then selects the indicator from the list to associate the indicator with the scene.

In step 340, the system 200 receives a selection of a first indicator. For example, in one embodiment a user may move a cursor over an indicator and select the indicator by clicking a mouse button. In another embodiment, the user may select an indicator from a drop down menu, or by touching a touch-sensitive surface over an indicator displayed on the screen. In a further embodiment, a user may select a plurality of indicators. For example, a user may select a first indicator and then select a second indicator. Such an embodiment may allow a user to hone in on a precise subset of scenes within the work to manipulate.

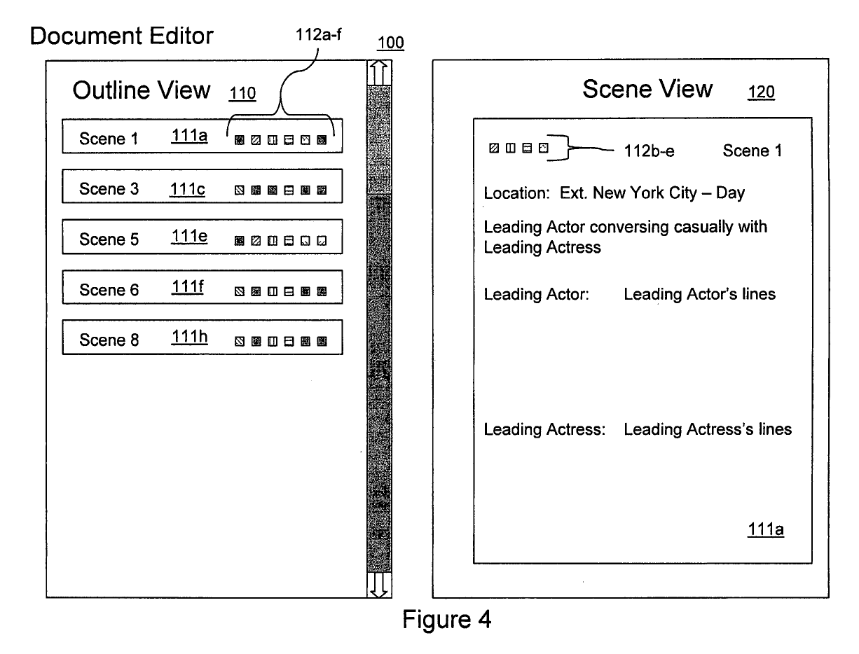

In step 350, the system 200 outputs scenes associated with the selected indicator. For example, in FIG. 1, an electronic document editor 231 has a movie script loaded. In the movie script, there are a plurality of frames 111a-j with at least one indicator associated with each scene (though it is possible that a scene may not have any indicators associated with it). A user editing the movie script may select indicator 112d, represented by a colored box within the outline view 110. After receiving the selection of the indicator, the system 200 changes the display of the outline view as can be seen in FIG. 4. FIG. 4 shows a software application for attribute indication and accessibility in electronic documents according to one embodiment. In the embodiment shown in FIG. 4, only the scenes with the selected indicator 112d are listed in the outline view 110. Thus, by selecting the desired indicator 112d, the user is able to quickly access all of the scenes with the characteristic associated with the indicator 112d—all the scenes with the leading actress in this embodiment.

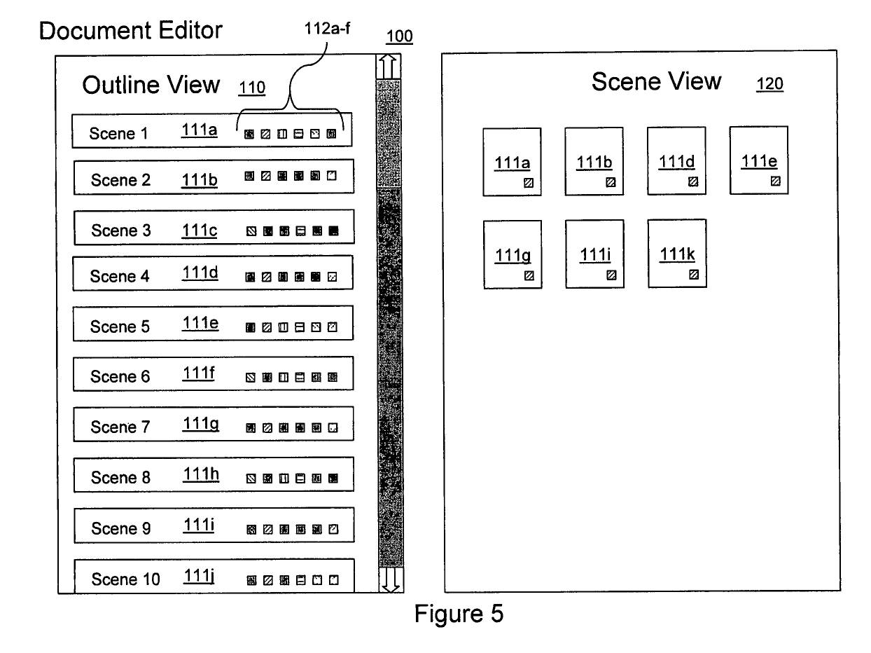

In another embodiment, the system 200 may output scenes associated with the selected indicator as shown in FIG. 5, which shows a software application for attribute indication and accessibility in electronic documents according to one embodiment. In the embodiment shown in FIG. 5, the system 200 has received a selection of an indicator 112b, and, unlike in FIG. 4, the system 200 has not changed the outline view 110, but rather has changed the scene view 120 to display representations of each of the scenes 111a,b,d,e,g,i,k associated with the selected indicator 112b. A user may then select one of the scenes in the subset shown in the scene view 120 to edit. In another embodiment, the system 200 displays the text of the scenes on successive pages, or in a single page, to allow the user to view and scroll through the text of the scenes in succession without needing to skip around in the larger electronic document.

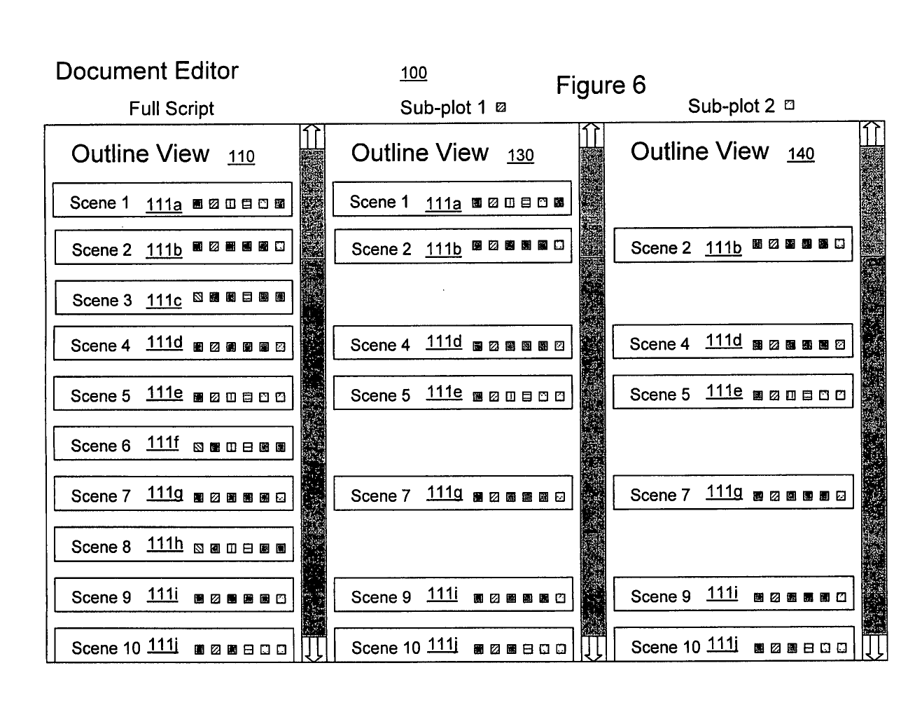

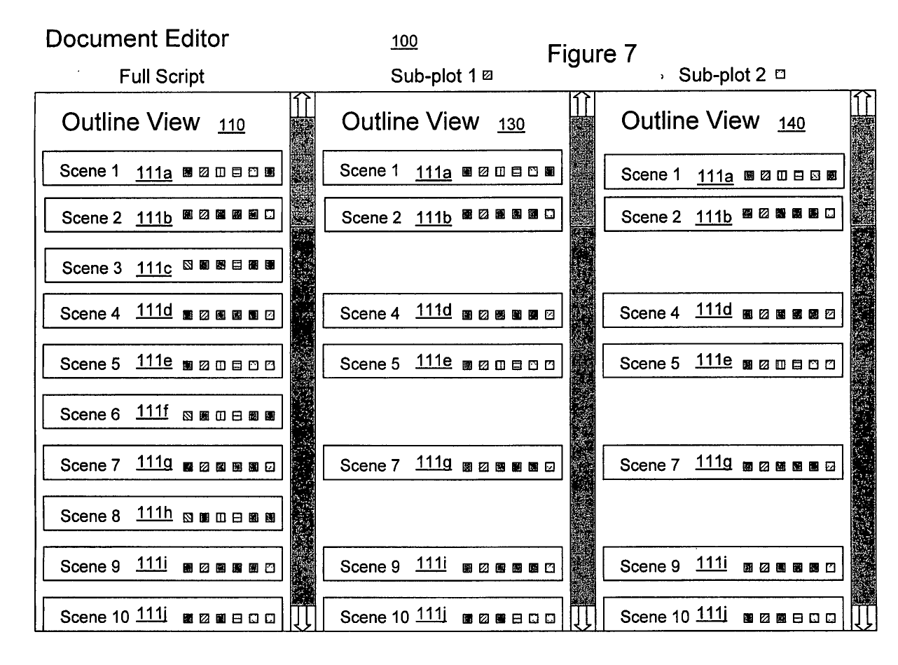

In another embodiment, the system 200 may output scenes associated with the selected indicator as shown in FIG. 6, which shows a software application for attribute indication and accessibility in electronic documents according to one embodiment. In the embodiment shown, the application 100 is configured to output a plurality of scene listings based on two selected indicators. In the embodiment shown, a user has selected indicators associated with sub-plot 1 and sub-plot 2. The application 100 has output the scenes associated with each sub-plot in additional outline views 130, 140. In the embodiment shown, each additional outline view 130, 140 comprises scenes associated with one of the selected indicators: outline view 130 shows the scenes associated with the indicator for sub-plot 1, while outline view 140 shows the scenes associated with the indicator for sub-plot 2. With such an embodiment, a user may be able to identify possible overlap between sub-plots, or may be able to identify when sub-plots within the script weave together to flesh out the story. A similar embodiment is shown in FIG. 7.

FIG. 7 shows a software application for attribute indication and accessibility in electronic documents according to one embodiment. In the embodiment shown in FIG. 7, indicators associated with sub-plot 1 and sub-plot 2 have been selected. The application 100 has output outline views 130 and 140 to display the scenes associated with each sub-plot. In the embodiment shown, however, a user has identified that scene 1 should be included with sub-plot 2. For example, the addition of the scene to sub-plot 2 may improve continuity with sub-plot 1, which, as can be seen in FIG. 6, differed from sub-plot 2 by just one scene. Thus, a user of the embodiment shown in FIG. 7 may be able to quickly identify that two sub-plots are closely related and to identify an additional characteristic of scene 1. Further, because the spacing between the scenes is maintained, it may provide a visual cue to a user of the application 100 that one scene is associated with each characteristic. In one embodiment, an indicator may be associated with one or more scenes where the indicator indicates a time of occurrence of the scene in the work. For example, multiple scenes may occur in sequence, or be spread throughout the script, but may actually depict events that happen simultaneously in the story. It may be possible to identify such temporal characteristics of one or more scenes to output to a user to provide a visual timeline of the scenes through the movie, such as with a plurality of views or in a report.

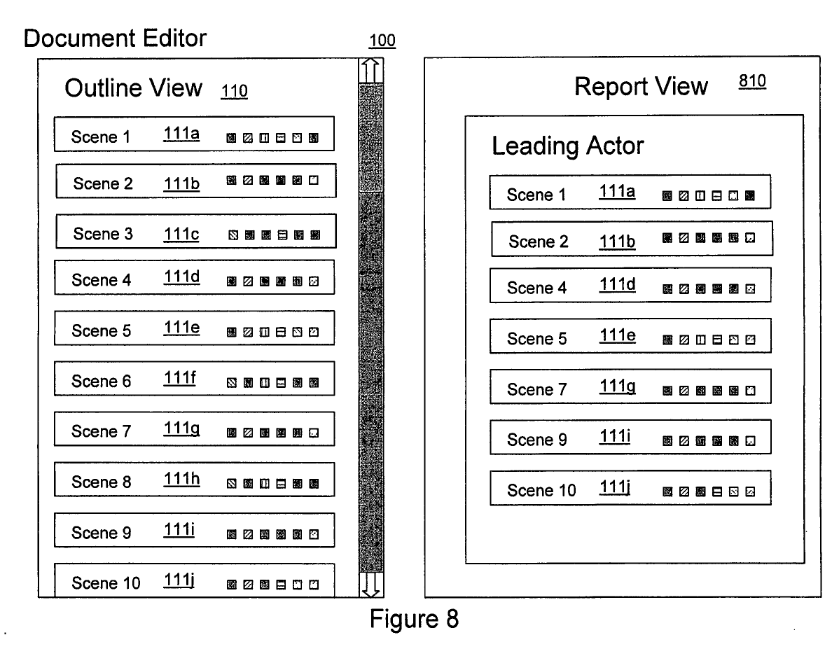

In another embodiment, the system 200 may output scenes associated with the selected indicator as shown in FIG. 8, which shows a software application for attribute indication and accessibility in electronic documents according to one embodiment. In the embodiment shown in FIG. 8, the application 100 has generated a report view 810 based at least in part on a selection of an indicator. For example, a user of the document may be interested in identifying scenes in which the leading actor appears. In the embodiment shown, a report has been generated for the user that includes the plurality of scenes in which the leading actor appears. The user may then save the report, print the report, email the report, or take other actions with the report. Such an embodiment may be useful to a plurality of different users of the document. For example, while a screen writer may draft a movie script, a large number of other individuals may need to access and work with the script, such as to generate reports for an actor with all the scenes the actor is in, for scenes at remote locations or with expensive equipment or special effects, or for editing or manipulating the movie script itself.

Referring again to FIG. 2, embodiments can be implemented in digital electronic circuitry, or in computer hardware, firmware, software, or in combinations of them. In one embodiment, a computer 201 may comprise a processor 210 or processors. The processor 210 comprises a computer-readable medium, such as a random access memory (RAM) coupled to the processor. The processor 210 executes computer-executable program instructions stored in memory 220, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable media, that may store instructions that, when executed by the processor, can cause the processor to perform the steps described herein as carried out, or assisted, by a processor. Embodiments of computer-readable media may comprise, but are not limited to, an electronic, optical, magnetic, or other storage or transmission device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other devices may be used, such as a router, private or public network, or other transmission device that comprises some form of computer-readable medium. The processor, and the processing, described may be in one or more structures, and may be dispersed through one or more structures. The processor may comprise code for carrying out one or more of the methods (or parts of methods) described herein.

### General

The foregoing description of embodiments has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

That which is claimed is:

1. A computer-implemented method, comprising:
identifying a plurality of characteristics associated with a work, the work comprising a plurality of scenes;
responsive to identifying the plurality of characteristics, for each of the plurality of characteristics, associating a different indicator with the respective characteristic and with scenes within the work having the respective characteristic;
inserting into the work one or more metadata tags for the different indicators, the metadata tags identifying locations of the characteristics within the work;
receiving a selection of a first indicator from the different indicators; and
responsive to receiving the selection of the first indicator, outputting scenes associated with the first indicator based on the one or more metadata tags.

2. (canceled)

3. (canceled)

4. The computer-implemented method of claim 1, wherein at least one of the plurality of characteristics comprises at least one of an actor, a location, or a time of day.

5. The computer-implemented method of claim 1, wherein outputting the scenes associated with the indicator comprises displaying representations of at least two of the scenes adjacent to each other.

6. The computer-implemented method of claim 1, wherein the indicator comprises a visual indicator comprising a shape and a color.

7. The computer-implemented method of claim 6, wherein at least one of the indicators is displayed with representations of the scenes associated with the indicator.

8. The computer-implemented method of claim 1, wherein the work script comprises a movie script, and the plurality of scenes comprise scenes in the movie script.

9. The computer-implemented method of claim 8, wherein the first characteristic corresponds to a character in the movie script.

10. The computer-implemented method of claim 1, wherein outputting the scenes associated with the indicator comprises outputting a report including the scenes associated with the indicator.

11. A non-transitory computer-readable medium on which is encoded program code, the program code comprising:
program code for identifying a plurality of characteristics associated with a work, the work comprising a plurality of scenes;
program code for, responsive to identifying the plurality of characteristics, for each of the plurality of characteristics, associating a different indicator with the respective characteristic and with scenes within the script having the respective characteristic;
program code for inserting into the work one or more metadata tags for the different indicators, the metadata tags identifying presence and locations of the characteristics within the work;
program code for receiving a selection of a first indicator from the different indicators; and
program code for, responsive to receiving the selection of the first indicator, outputting scenes associated with the first indicator based on the one or more metadata tags.

12. The non-transitory computer-readable medium of claim 11, wherein the program code for outputting the scenes associated with the indicator comprises program code for displaying representations of at least two of the-scenes adjacent to each other.

13. The non-transitory computer-readable medium of claim 11, wherein the indicator comprises a visual indicator comprising a shape and a color.

14. (canceled)

15. (canceled)

16. The non-transitory computer-readable medium of claim 11, wherein the program code for outputting the scenes associated with the indicator comprises program code for outputting a report including the scenes associated with the indicator.

17. A system, comprising:
a memory comprising an electronic document;
a processor in communication with the memory, the processor configured to:
identify a plurality of characteristics associated with a work, the work comprising a plurality of scenes
responsive to identifying the plurality of characteristics, associate a different indicator with the respective characteristic and with scenes within the work having the respective characteristic;
insert into the work one or more metadata tags for the different indicators, the metadata tags identifying locations of the characteristics within the work;
receive a selection of a first indicator from the different indicators; and
responsive to receiving the selection of the first indicator, outputting scenes associated with the first indicator based on the one or more metadata tags.

18. The system of claim 17, wherein the processor is further configured to output the scenes associated with the indicator-by displaying representations of at least two of the scenes adjacent to each other.

19. The system of claim 17, wherein the indicator comprises a visual indicator comprising a shape and a color.

20. (canceled)

21. (canceled)

22. The system of claim 17, wherein the processor is further configured to output the scenes associated with the indicator by outputting a report including the scenes associated with the indicator.

23. The computer-implemented method of claim 1, wherein the indicator is distinct from the characteristic.

24. The non-transitory computer-readable medium of claim 11, wherein the indicator is distinct from the characteristic.

25. The system of claim 17, wherein the indicator is distinct from the characteristic.

26. The non-transitory computer-readable medium of claim 11, wherein the work comprises a movie script, and the plurality of scenes comprise scenes in the movie script.

27. The system of claim 17, wherein the work comprises a movie script, and the plurality of scenes comprise scenes in the movie script.

28. The method of claim 1, wherein the metadata tags comprise XML tags.
